(19) United States
(12) Patent Application Publication
(10) Pub. No.: US 2007/0018609 A1
(43) Pub. Date: Jan. 25, 2007

(54) Battery charger

(76) Inventor: Jen-Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/174,638

(22) Filed: Jul. 6, 2005

(51) Int. Cl. H02J 7/00

(52) U.S. Cl. 320/107

(57) ABSTRACT

A battery charger is disclosed to include a rectifier for rectifying AC into DC, two terminal clamps for clamping on the battery to be charged, and a polarity control electrically connected between the rectifier and the terminal clamps for controlling the polarity of the two terminal clamps to match with the polarity of the positive and negative metal contacts of the battery to be charged.

### BACKGROUND OF THE INVENTION

1. Field of the Invention

The present invention relates to a battery charger and more particularly, to a simple structure of battery charger practical for charging any of a variety of secondary battery for mobile telephones.

2. Description of the Related Art

A variety of battery chargers for mobile telephone have been disclosed and have appeared on the market. These battery chargers have a specific specification that fits one particular model of battery or mobile telephone. For charging the battery of a different mobile telephone, a different battery charger shall be used.

### SUMMARY OF THE INVENTION

The present invention has been accomplished under the circumstances in view. It is the main object of the present invention to provide a battery charger, which fits any of a variety of secondary battery for mobile telephone. To achieve this and other objects of the present invention, the battery charger comprises a rectifier for rectifying AC into DC, two terminal clamps for clamping on the positive and negative metal contacts of any of a variety of commercial battery to be charged, and a polarity control electrically connected between the rectifier and the terminal clamps for controlling the polarity of the two terminal clamps to match with the polarity of the positive and negative metal contacts of the battery to be charged.

### BRIEF DESCRIPTION OF THE DRAWINGS

FIG. 1 is an exploded view of a battery charger according to the present invention.

FIG. 2 is a schematic top plain view of a part of the present invention, showing a charging operation of the battery charger.

FIG. 3 is a side view in section of a part of the present invention, showing the terminal clamp clamped on the respective metal contact of a secondary battery.

### DETAILED DESCRIPTION OF THE PREFERRED EMBODIMENT

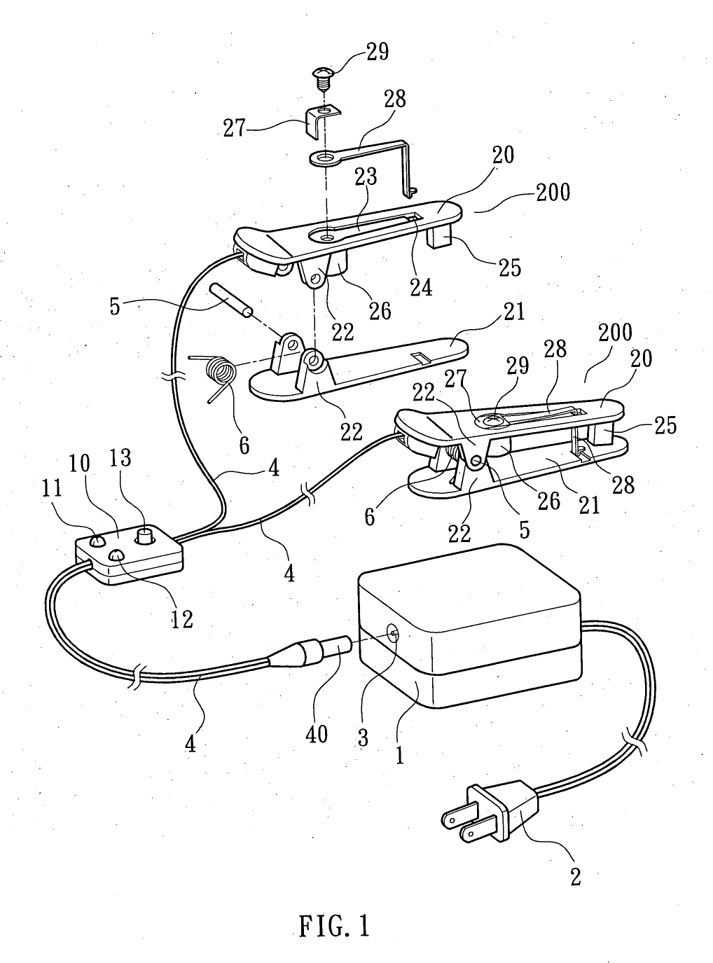

Referring to FIGS. 1˜3, a battery charger in accordance with the present invention is shown comprising a rectifier 1, a polarity control 10, and two terminal clamps 200.

The rectifier 1 has a power input cable 2 and a DC output jack 3, and is adapted to rectify AC power supply into DC power supply for charging a battery 7.

The polarity control 10 has an input end electrically connected to the DC output jack 3 of the rectifier 1 through an electric wire 4 and a plug 40, an output end electrically connected to the terminal clamps 200 through a respective electric wire 4, a polarity switch 13 for switching the positive and negative polarity between the two electric wires 4 to the terminal clamps 200, an indicator light 11, which is turned on to indicate the operation status of the polarity control 10 when DC power supply passes therethrough from the rectifier 1 to the terminal clamps 200, and a polarity light 12, which is turned on when the two electric wires 4 matches the metal contacts 8 of the battery 7 in polarity.

The two terminal clamps 200 are identical, each comprising a first electrically insulative clamping arm 20, a second electrically insulative clamping arm 21, a pivot 5 fastened to respective lugs 22 of the clamping arms 20 and 21 to pivotally secure the two clamping arms 20 and 21 together, and a torsional spring 6 mounted on the pivot 5 and stopped between the clamping arms 20 and 21 to support the clamping arms 20 and 21 in the close position. The first clamping arm 20 has a locating groove 23 longitudinally disposed at the top side, a through hole 24 disposed at one end of the through the top and bottom sides, a rear bottom female screw 26, and a front bottom pressure block 25. Each terminal clamp 200 further comprises a first metal conducting plate 27 and a second metal conducting plate 28. The first metal conducting plate 27 and the second metal conducting plate 28 are fastened together and affixed to the top side of the rear bottom female screw 26 with a screw 29. The first metal conducting plate 27 is fixedly and electrically connected to one electric wire 4. The second metal conducting plate 28 is an angled member having a horizontal part fitted into the locating groove 23 and a vertical part inserted through the through hole 24.

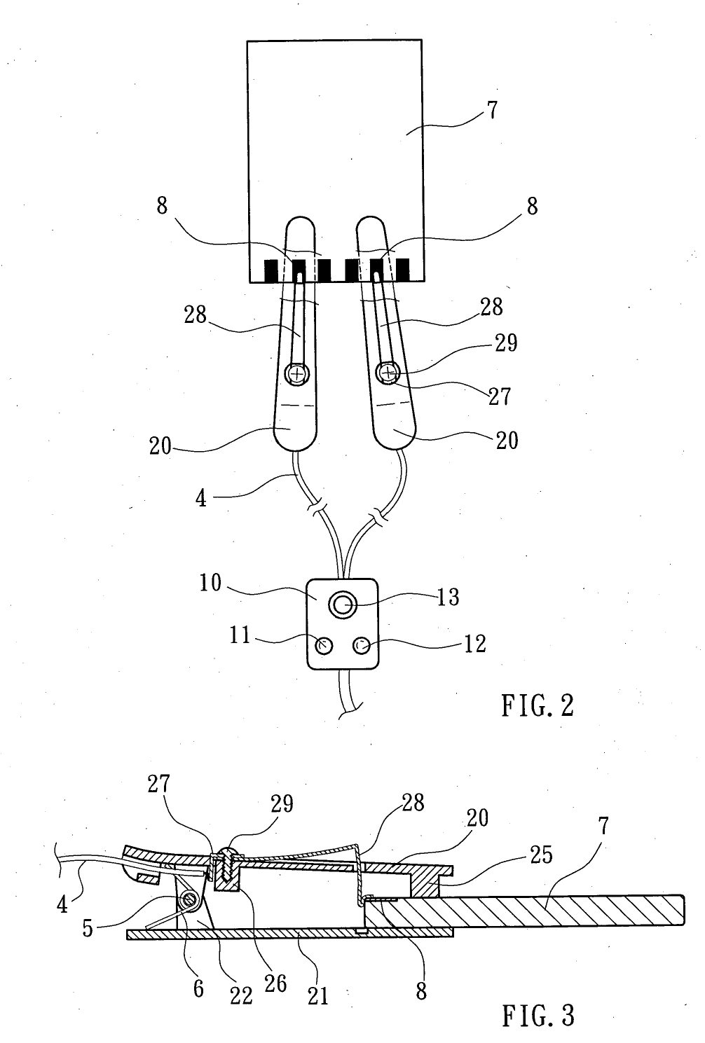

Referring to FIGS. 1 and 2 again, the two terminal clamps 200 and respectively clamped on the battery 7 to be charged, keeping the second metal conducting plates 28 of the two terminal clamps 200 in close contact with the respective metal contacts 8 of the battery 7, and then the power input cable 2 is connected to an AC power supply outlet, for enabling the rectifier 1 to rectify AC power supply into the desired DC power supply for charging the battery 7. If the a polarity light 12 is off after installation of the battery charger, switch the polarity switch 13 to exchange the polarity between the two electric wires to the terminal clamps 200 so that DC power supply can be outputted from the rectifier 1 through the polarity control 10 to the terminal clamps 200 and then the metal contacts 8 of the battery 7 to charge the battery 7 to the saturated status.

As indicated above, the present invention provides a battery charger, which can conveniently electrically connected to the metal contacts of any of a variety of secondary battery by means of the terminal clamps 200, for enabling the secondary battery to be charged with DC power supply obtained from AC power supply through the rectifier 1 subject to the control of the polarity control 10.

A prototype of battery charger has been constructed with the features of FIGS. 1˜3. The battery charger functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A battery charger comprising:
a rectifier adapted to rectify AC power supply into DC power supply for charging a secondary battery, said rectifier having a power input cable for connection to AC power supply and a DC output jack for DC output;
two terminal clamps for clamping on positive and negative metal contacts of the battery to be charged, said terminal clamps each comprising a first electrically insulative clamping arm, said first clamping arm having a top locating groove, a through hole at one end of said top locating groove, a rear bottom female screw, and a front bottom pressure block, a second electrically insulative clamping arm, a pivot fastened to said first clamping arm and said second clamping arm to pivotally secure the two clamping arms together, a torsional spring mounted on said pivot and stopped between said first clamping arm and said second clamping arm to support the two clamping arms in a close position, a metal conducting plate affixed to a top side of said rear bottom female screw with a screw and fitted into said locating groove, said metal conducting plate having a rear end electrically connected to said rectifier and a front end inserted through said through hole for contacting one metal contact of the battery to be charged; and
a polarity control electrically connected between said rectifier and said terminal clamps for controlling the polarity of said terminal clamps, said polarity control having a cable extending from an input end thereof for connection to the DC output jack of said rectifier, an output end electrically connected to the metal conducting plates of said terminal clamps through a respective electric wire, a polarity switch for switching the positive and negative polarity between the two electric wires to said terminal clamps, an indicator light, which is turned on to indicate the operation status of said polarity control when DC power supply passes therethrough from said rectifier to said terminal clamps, and a polarity light, which is turned on when the two electric wires to said terminal clamps matches the polarity of the positive and negative metal contacts of the battery to be charged.
